(19) United States
(12) Patent Application Publication
(10) Pub. No.: US 2017/0166008 A1
(43) Pub. Date: Jun. 15, 2017

(54) TIRE STRENGTHENING SYSTEM

(71) Applicant: Erick Hines, Westchester, IL (US)

(72) Inventor: Erick Hines, Westchester, IL (US)

(21) Appl. No.: 15/374,834

(22) Filed: Dec. 9, 2016

Related U.S. Application Data
(60) Provisional application No. 62/266,170, filed on Dec. 11, 2015.

(51) Int. Cl. B60C 5/14

(52) U.S. Cl. CPC B60C 5/14

(57) ABSTRACT

A tire strengthening system for strengthening a tire is provided. The tire has an inner surface and an inner tube positioned against the inner surface with the inner surface having a pair of sidewalls and a tread area between the sidewalls. The tire strengthening system comprises an adhesive layer applied to the inner surface of the tire and a strengthening material positioned on the adhesive layer. The combined adhesive layer and strengthening material reinforces the structural integrity of the tire, enabling the tire to run longer and smoother and effectively preventing flat tires and blowouts from occurring.

### CLAIM OF PRIORITY

This patent application claims priority under 35 USC 119 (e) (1) from U.S. Provisional Patent Application Ser. No. 62/266,170 filed Dec. 11, 2015, of common inventorship herewith entitled, “Wheels,” which is incorporated herein by reference as though the same were set forth in its entirety.

### FIELD OF THE INVENTION

The present invention pertains to the field of automobile tires, and more specifically to the field of tire strengthening systems involving adhesive and a strengthening material.

### BACKGROUND OF THE INVENTION

Millions of people climb into their cars, trucks or minivans every day to make their way across national and local highways and byways. Whether a retired couple embarking on a cross country journey, a college coed enduring a long commute to school or a busy homemaker driving a few blocks to the neighborhood grocer, automobiles provide a simple way in which to get from one place to another both safely and easily. Perhaps the greatest invention of modern history, the introduction of the automobile vastly changed landscapes around the world. Facilitating safe and speedy travel, the evolution of this practical piece of machinery continues to this day. Automobiles are produced in an almost endless variety of makes and models. From rugged SUV's and trucks, to luxury sedans and minivans, there is a model and make vehicle to satisfy the needs of virtually any motorist.

Perhaps the most important component of any automobile is a set of tires. Effortlessly carrying the weight of the entire vehicle as well as passengers and luggage, a good set of tires is a crucial factor in any safe road trip. Quality tires provide reliable traction when traveling in the rain, sleet or snow and can vastly improve a cars overall performance. A set of expensive tires does little good if one tire in the set is flat. Whether a result of a slow leak, a puncture, dry rot or simple wear and tear, a flat tire is a hassle to change and often results in expensive repair and replacement costs. Discovering one's parked vehicle has a fiat tire is frustrating, but experiencing a blowout when operating the vehicle is extremely dangerous. A blowout is a sudden release of air pressure in the tire which usually occurs as a result of driving over a sharp or pointed object. Difficult to control, this almost instantaneous deflation often causes the vehicle to spin off course, rendering the driver unable to keep their vehicle on the road. For those lucky enough to safely control their vehicle during a blowout, many are nonetheless faced with the prospect of being stranded.

The prior art has put forth several designs for tire strengthening formulas. Among these are:

U.S. Pat. No. 8,221,849 to Mitsuru Naito describes a process in which a self sealing pneumatic tire, consisting of a pneumatic tire after vulcanization molding furnished with a sealant layer being uniform without thickness irregularity and a cover sheet layer, is produced without the use of an organic solvent and expensive apparatus and an apparatus therefore. The process is characterized by sequentially performing the operations of injecting a viscous sealant material onto the internal surface of a pneumatic tire after vulcanization molding. The sealant material is diffused into sheet form by centrifugal force while rotating the pneumatic tire around the tire axis to thereby form a sealant layer. A cover material of an uncured super resilient adhesive formula is coated on the interior surface of existing or newly manufactured tire walls, prior to installing the tire's inflatable inner tube. A rubber or resin material is injected onto the inside surface of the sealant layer. The cover material is diffused into a sheet form by centrifugal force while rotating the pneumatic tire around the tire axis to thereby form a cover sheet layer. The cover sheet layer is irradiated with electron beams, infrared rays, ultraviolet rays or ultrasonic waves to thereby harden the same.

U.S. Pat. No. 4,057,090 to Katuyuki Hoshikawa, Soji Noda and Akitaka Kimura describes a pneumatic tire including a puncture sealing layer which is applied to an inner lining. By addition of specific amounts of polyisobutylene and of a particular form of silica with respect to a set amount of polybutene and by use of powdered elastomer having a specific particle size distribution, there are achieved optimum values of viscosity and adhesivity and ability to seal even large puncture holes in a wide range of temperature and operating conditions. There is less tendency for puncture sealing layer components to migrate to the inner lining and tire durability is improved,

U.S. Pat. No. 3,935,893 to Peter L. Stang and Joel V. Van Ornum describes a vehicle tire having an internal circumferential layer of self sealing composition on an internal surface, particularly behind the tire tread. The sealant layer is initially made up of the combination of specific quantities of a high molecular weight curable butyl rubber, a low molecular weight curable butyl rubber, a liquid polybutylene tackifier, a partially hydrogenated block copolymer of styrene and a conjugated diene, carbon black and suitable curing agents for the butyl rubber components. When cured, this sealant layer effectively heals most punctures one quarter inch in diameter or less in a vehicle tire at temperatures from a range of about twenty degrees below zero to two hundred seventy degrees Fahrenheit without significant loss of air.

None of these prior art references describe the present invention.

### SUMMARY OF THE INVENTION

It is an object of the present invention to provide a super resilient adhesive and strengthening formula to be coated on the interior surface of existing or newly manufactured tire walls, prior to installing the tire's inflatable inner tube.

The present invention is a tire strengthening system for strengthening a tire. The tire has an inner surface and an inner tube positioned against the inner surface with the inner surface having a pair of sidewalls and a tread area between the sidewalls. The tire strengthening system comprises an adhesive layer applied to the inner surface of the tire and a strengthening material positioned on the adhesive layer. The combined adhesive layer and strengthening material reinforces the structural integrity of the tire, enabling the tire to run longer and smoother and effectively preventing flat tires and blowouts from occurring.

In addition, the present invention includes a method for strengthening a tire. The tire has an inner surface and an inner tube positioned against the inner surface with the inner surface having a pair of sidewalls and a tread area between the sidewalls. The method comprises applying an adhesive layer to the inner surface of the tire, positioning a strengthening material on the adhesive layer, reinforcing the structural integrity of the tire, enabling the tire to run longer and smoother, and effectively preventing flat tires and blowouts from occurring.

The present invention further includes a tire strengthening system for strengthening a tire, The tire has an inner surface and an inner tube positioned against the inner surface with the inner surface having a pair of sidewalls and a tread area between the sidewalls. The tire strengthening system comprises a liquid adhesive layer applied to the inner surface of the tire with the adhesive layer being resilient upon drying. A Kevlar strengthening material is positioned on the adhesive layer prior to the adhesive layer drying. The combined adhesive layer and strengthening material reinforces the structural integrity of the tire, enabling the tire to run longer and smoother and effectively preventing flat tires and blowouts from occurring.

### BRIEF DESCRIPTION OF THE DRAWINGS

FIG. 1 is a perspective view illustrating a layer of a tire strengthening system, constructed in accordance with the present invention, applied within an automobile tire and incorporating an adhesive layer and a strengthening material such as Kevlar™, for example.

FIG. 2 is a sectional perspective view illustrating the layer of the tire strengthening system, constructed in accordance with the present invention, applied within the automobile tire and incorporating an adhesive layer and a strengthening material such as Kevlar™ for example.

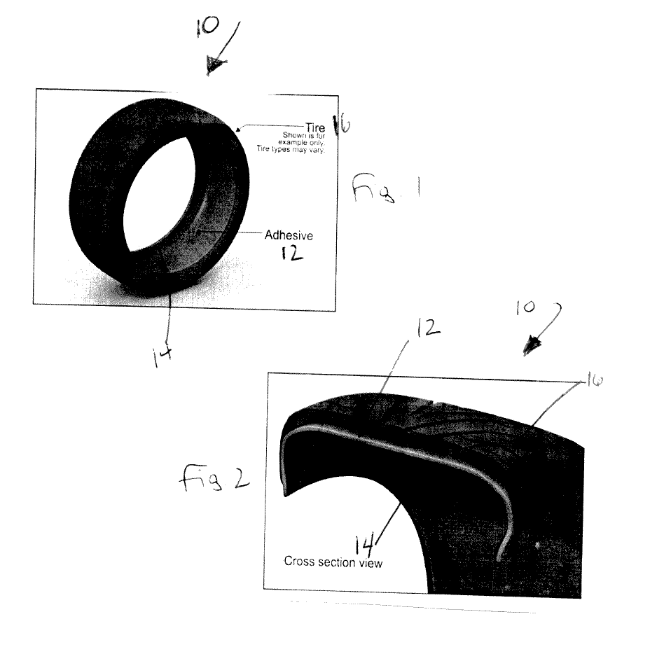

### DETAILED DESCRIPTION OF THE INVENTION

The present invention, hereinafter referred to as a Tire Strengthening System, indicated generally at 10, is a super resilient adhesive layer 12 and strengthening material 14 incorporating Kevlar™ to be coated on the interior surface of existing or newly manufactured tires 16, prior to installing the tires 16 and the tires 16 having an inflatable inner tube in them. Using the Tire Strengthening System 10 provides additional functionality to reinforce the structural integrity of the tire 16, enabling the tire 16 to run longer and smoother than traditional tires and effectively preventing flat tires and blowouts from occurring. The adhesive 12 and the strengthening material 14, such as Kevlar™, for example, can be available as an aftermarket accessory to be applied to existing vehicle tires 16. The adhesive 12 and the strengthening material 14, such as Kevlar™, for example also is incorporable into the configuration of newly manufactured tires 12 and applied during the production process.

The Tire Strengthening System 10 of the present invention is the adhesive 12 together with the strengthening material 14 combined with the adhesive 12. Preferably, the adhesive 12 is a liquid formula applied directly to the inside surface of the tire 16. In a preferred embodiment, the adhesive 16 is applied to the entire inside surface of the tire 12 including the area opposite the tread and the sidewalls. It is within the scope of the present invention, however, for the adhesive 12 to be applied to only a portion of the inside surface of the tire 16, i.e., only the inside surface of the tire opposite the tread. The strengthening material 14 is positioned over any area where the adhesive 12 is present.

The adhesive 12 of the Tire Strengthening System 10 of the present invention is capable of drying within approximately twenty (20) minutes of application. Before the adhesive 12 is dry, the strengthening material 14, such as Kevlar™, for example, is applied and the combination of adhesive 12 and strengthening material 14 dries to a flexible but impenetrable shell. The adhesive 12 is available as a spray on or a viscous fluid that is directly painted on the interior tire walls 16.

In each case, the application of the adhesive 12 and the Kevlar strengthening material 14 of the Tire Strengthening System 10 of the present invention involves liberally applying the adhesive 14 so the adhesive 12 encompasses the interior of the tire 16 completely. Once applied, the adhesive 12 and Kevlar strengthening material 14 cures and dries to a flexible, yet impenetrable shell that functions to reinforce the structural integrity of the tire 16 while also preventing damage to the inner tube inserted within the tire 16.

If a motorist drives over sharp objects such as nails or glass, or is punctured with a knife, the applied Tire Strengthening System 10 of the present invention, i.e., the adhesive 12 and the Kevlar strengthening material 14, becomes a reliable barrier that prevents the object from puncturing through the tire and inner tube and causing a blowout. The Tire Strengthening System 10 also prevents slow leaks from occurring.

The Kevlar strengthening material of the Tire Strengthening System 10 of the present invention is strong enough to stop bullets and knives and is often described as being stronger than steel of equal weight. The adhesive 12 can be sprayed on or painted on the inner tire wall then position the Kevlar strengthening material on the adhesive to dry so they become a strong and flexible yet impenetrable tough shell. In each case, the application of the adhesive 12 and the Kevlar strengthening material 14 can involve liberally applying the formula so it encompasses the interior of the tire wall 16 completely. Once applied, the adhesive layer 12 and the Kevlar strengthening material 4 cures and dries to a flexible yet impenetrable shell that functions to reinforce the structural integrity of the tire 16 while also preventing damage to the tire 16 and to tires 16 with inner tubes in them.

The Tire Strengthening System 10 of the present invention protects the integrity of an inner tube within the tire 16 during daily use, thus preventing slow leaks or flats from occurring. As an impenetrable and flexible adhesive coating 12 that encompasses the interior of the tire wails 16 the Tire Strengthening System 10 withstands elemental exposure that leads to dry rot, punctures and excessive wear. Withstanding repeated use and continued exposure to the elements, and formulated specifically for use on automobiles and light trucks, the Tire Strengthening System 10 also is applicable to a wide range of tires including motorcycle, bicycle and trailer tires. A durable and strong formulation, the Tire Strengthening System 10 will protect tires 16 and withstand many miles of use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A tire strengthening system for strengthening a tire, the tire having an inner surface and an inner tube positioned against the inner surface, the inner surface having a pair of sidewalls and a tread area between the sidewalls, the tire strengthening system comprising:
an adhesive layer applied to the inner surface of the tire; and
a strengthening material positioned on the adhesive layer;
wherein the combined adhesive layer and strengthening material reinforces the structural integrity of the tire, enabling the tire to run longer and smoother and effectively preventing flat tires and blowouts from occurring.

The tire strengthening system of claim 1 wherein the adhesive layer is resilient.

3. The tire strengthening system of claim 1 wherein the adhesive layer is applied as a liquid formula.

4. The tire strengthening system of claim 3 wherein the adhesive layer is sprayed on the inner surface of the tire.

5. The tire strengthening system of claim 3 wherein the adhesive layer is applied on the inner surface of the tire by a brush.

6. The tire strengthening system of claim 3 wherein the adhesive layer dries within approximately twenty (20) minutes of application.

7. The tire strengthening system of claim 3 wherein the strengthening material is positioned on the adhesive layer prior to the adhesive layer drying.

8. The tire strengthening system of claim 1 wherein the combined adhesive layer and strengthening material is applied to the entire inside surface of the tire.

9. The tire strengthening system of claim 1 wherein the combined adhesive layer and strengthening material is applied to only a portion of the inside surface of the tire.

10. The tire strengthening system of claim 1 wherein the strengthening material includes Kevlar™.

11. A method for strengthening a tire, the tire having an inner surface and an inner tube positioned against the inner surface, the inner surface having a pair of sidewalls and a tread area between the sidewalls, the method comprising:
applying an adhesive layer to the inner surface of the tire;
positioning a strengthening material on the adhesive layer;
reinforcing the structural integrity of the tire;
enabling the tire to run longer and smoother; and
effectively preventing flat tires and blowouts from occurring.

12. A tire strengthening system for strengthening a tire, the tire having an inner surface and an inner tube positioned against the inner surface, the inner surface having a pair of sidewalls and a tread area between the sidewalls, the tire strengthening system comprising:
a liquid adhesive layer applied to the inner surface of the tire, the adhesive layer being resilient upon drying; and
a Kevlar strengthening material positioned on the adhesive layer prior to the adhesive layer drying;
wherein the combined adhesive layer and strengthening material reinforces the structural integrity of the tire, enabling the tire to run longer and smoother and effectively preventing flat tires and blowouts from occurring.

13. The tire strengthening system of claim 12 wherein the adhesive layer is sprayed on the inner surface of the tire.

14. The tire strengthening system of claim 12 wherein the adhesive layer is applied on the inner surface of the tire by a brush.

15. The tire strengthening system of claim 12 wherein the adhesive layer dries within approximately twenty (20) minutes of application.

16. The tire strengthening system of claim 12 wherein the combined adhesive layer and strengthening material is applied to the entire inside surface of the tire.

17. The tire strengthening system of claim 12 wherein the combined adhesive layer and strengthening material is applied to only a portion of the inside surface of the tire.
